(19) United States
(12) Patent Application Publication
(10) Pub. No.: US 2015/0234118 A1
(43) Pub. Date: Aug. 20, 2015

(54) PANEL ILLUMINATION SYSTEM

(71) Applicant: THOMSON LICENSING, Issy de Moulineaux (FR)

(72) Inventor: William Phillip Dernier, Indianapolis, IN (US)

(73) Assignee: THOMSON LICENSING, Issy de Moulineaux (FR)

(21) Appl. No.: 14/425,222

(22) PCT Filed: Sep. 18, 2013
(86) PCT No.: PCT/US2013/060324

§ 371 Date: Mar. 2, 2015

Related U.S. Application Data
(60) Provisional application No. 61/703,418, filed on Sep. 20, 2012.

(51) Int. Cl. F21V 8/00; G09F 13/02

(52) U.S. Cl. CPC G02B 6/0096; G09F 13/02

(57) ABSTRACT

A system and method for illuminating at least a portion of an exterior surface of an apparatus or enclosure are described. A light pipe has a first portion for receiving light from a source inside the enclosure, and a second portion for directing the received light onto the exterior surface of the enclosure.

### CROSS-REFERENCES TO OTHER APPLICATIONS

This application claims priority to U.S. Provisional application Ser. No. 61/703,418, “Panel Illumination System for a Set Top Box” filed on Sep. 20, 2012, which is herein incorporated by reference in its entirety.

### TECHNICAL FIELD

This invention relates to a system for illuminating an exterior surface or panel of a piece of equipment or electronic device.

### BACKGROUND

Many manufacturers find it desirable to provide logos, symbols, or other marks on their electronic devices such as set top boxes or the like to enhance the aesthetics and/or promote corporate identity. Logos, symbols or marks are typically illuminated with backlighting to improve their visibility. Unfortunately, backlighting such targets (logos, symbols, marks and so on) is often difficult and expensive, because the backlighting must have high brightness to propagate through the backs of these targets, and the lighting elements tend to have surface areas nearly as large as or slightly larger than the target. It is desirable to have alternative systems with more compact or smaller size lighting elements that can produce similar or comparable results as backlighting systems.

### SUMMARY OF THE INVENTION

Embodiments of the present principles provide apparatus and method for illuminating an exterior surface or panel of a device or enclosure.

One embodiment provides a light pipe for illuminating an exterior surface of an enclosure, the light pipe includes a first portion inside the enclosure for receiving light from a source; and a second portion for directing the received light onto the exterior surface of the enclosure.

Another embodiment provides a method of illuminating an exterior surface of an enclosure, the method includes coupling light into a first portion of a light pipe inside the enclosure; and directing light from the light pipe onto the exterior surface of the enclosure.

Yet another embodiment provides a system for illuminating an exterior surface of an enclosure, the system includes a light source inside the enclosure; a light pipe having a first portion inside the enclosure for receiving light from the light source; and a second portion for directing the received light onto the exterior surface of the enclosure.

### BRIEF DESCRIPTION OF THE DRAWINGS

The teachings of the present invention can be readily understood by considering the following detailed description in conjunction with the accompanying drawings, in which:

FIG. 1 is a perspective view of a portion of a set top box with front panel illumination according to the present principles;

FIG. 2 is a cross sectional view of an interior portion of the set top box with a panel illumination system according to one embodiment of the present principles;

FIG. 3 is a side view of a front portion of a light pipe for illuminating an exterior part of the set top box; and

FIG. 4 is a perspective view of a light pipe according to another embodiment of the present principles.

To facilitate understanding, identical reference numerals have been used, where possible, to designate identical elements that are common to the figures.

### DETAILED DESCRIPTION

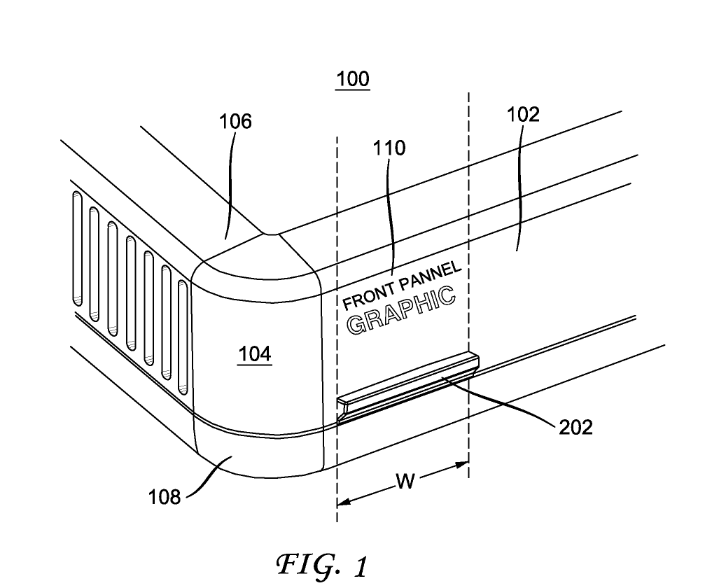

FIG. 1 is a perspective view of an electronic device or apparatus 100 such as a set top box with an enclosure or housing 104 having a top 106, a bottom 108 and a front panel or surface 102. The front panel 102 has a logo, symbol or other marks 110 that the manufacturer intends to illuminate. This can be done to promote corporate identity, to better market the device or its features, or as an indicator of the power-on status of the device, in a situation where the intent is for the illumination to be activated only when the device in on. The logo, symbol, markings, or any area of the device (e.g., the enclosure or housing) to be illuminated, can be referred to as a target or target area. One aspect of the present principles provides illumination of the target by directing light onto an exterior side of the target, e.g., on an outside surface of the enclosure 104.

In the example of FIG. 1, a portion 202 of a light pipe protrudes the front panel 102 and provides light directly to illuminate the exterior side of a target 110. This exterior portion 202 of the light pipe has a width W, which can be about the same width as the target area.

The logos or targets can be silk screened on the front panel 102. These targets can be illuminated separately from the illumination of front panel buttons, for example, using a different light source and/or configuration.

In this case, the exterior portion 202 of the light pipe is configured so that light propagates upwards at skimming or grazing angles, i.e., obtuse angles of incidence with respect to the surface of the front panel 102 on which the target is located.

In general, the range of angles is selected based on performance requirements, which depend on the specific device or panel configuration and target design. For a fixed light intensity output, a larger grazing angle of incidence will result in a larger illuminated area, though with reduced brightness.

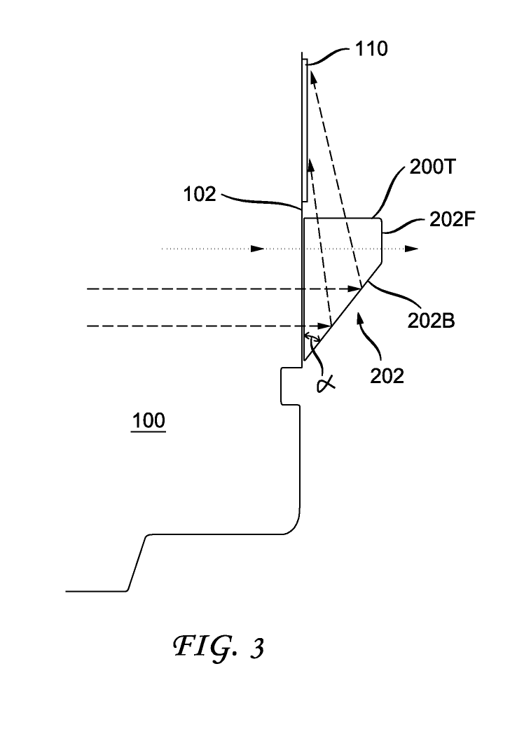

The light pipe can also illuminate at least a portion of the front panel 102 of the device 100 around the target 110, and optionally, the light pipe can be designed to permit some light to propagate or transmit through the light pipe's front surface (to be discussed further with reference to FIG. 3). With this illumination configuration, the front panel 102 and the target or logo can be illuminated with sufficient brightness to be pleasantly noticeable without causing a viewer to see “spots” due to excess brightness. In one embodiment, the front panel 102 of the set top box 100 can be black and the target 110 can be white silk-screened graphics intended to provide a subtle cast or warm basking of light.

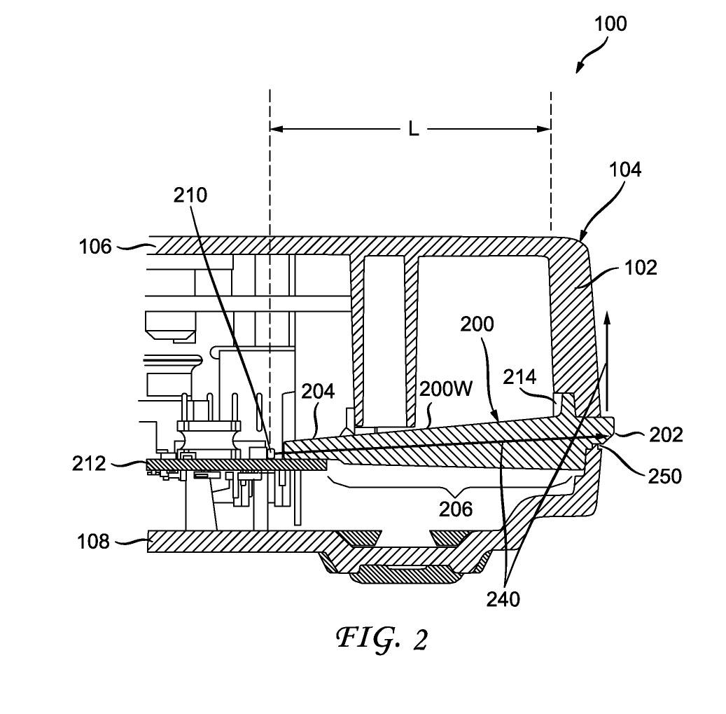

FIG. 2 shows a cross-sectional view of an interior portion of the set top box 100 with a panel illumination system that includes a light pipe 200 and light source 210. The light source 210 and most of the light pipe 200 are inside the enclosure or housing 104, with a portion near the front of the light pipe 200 mounted to the front panel 102 between the bottom 108 and top 106 of the enclosure 104. The light pipe 200 can be secured to the front panel 102 by a flange 214 and other fasteners. Optionally, an alignment mechanism can also be provided for aligning the light pipe to optimize the illumination effect.

As shown in FIG. 2, the light pipe 200 has a first portion 204 proximate the light source 210 for receiving or coupling light into the light pipe 200, and a second portion, i.e., the exterior, protruded portion 202 for directing the received light to an exterior surface of the enclosure 104, which in this case, is the front panel 102. The first portion 204 can be referred to as a light input portion, and the exterior portion 202 can be referred to as a light output portion of the light pipe.

In this example, the end of the first portion 204 closer to the light source 210 (i.e., input end of the light pipe) has a smaller cross-sectional area compared to that of the output end of the exterior portion 202. A middle portion 206 is located between the light input and output portions 204 and 202. This middle portion 206 is also referred to as an expanding light channel portion, because it has at least one of: a width and a height (i.e., width, or height, or both) increasing towards the light output portion 202 positioned near the front panel 102. This expanding channel design results in a larger illumination coverage area, as well improved light uniformity. The light output portion 202 has dimensions, e.g., a height and a width, that allow it to fit through an aperture or slot 250 in the front panel 102, so that it is located outside the enclosure 104. The dimensions of various portions of the light pipe are selected based on specific design requirements or constraints. The target 110 is not shown in this figure, but can be integrated into the panel 102.

The exterior walls (e.g., 200W) that run along or substantially parallel to the central longitudinal axis of the light pipe 200 should be sufficiently polished, so that the surfaces can enhance or promote total internal reflection of the light as it propagates through the pipe 200. The general directions of light propagation are shown by the arrows 240.

Different materials can be used for the light pipe 200, but in general, it is preferably made of a material capable of a high gloss surface finish, which improves total internal reflection and results in more efficient light transmission. A material with better light diffusion property will also allow the light to better fill the light pipe, which can result in improved illumination uniformity. Suitable light pipe materials include, for example, solid clear plastic, translucent materials, polycarbonate resins, or glass, among others. A hollow metal tube or optical fiber bundle may also be used. In one embodiment, a polycarbonate such as LEXAN FXD121R is used, which is available from SABIC Innovative Plastics of Pittsfield, Mass.

The light source 210 can be one or more light emitting diodes (LED) or one or more laser diodes, or other suitable light source. The source 210 can be mounted on a circuit board 212, which can be flat and generally horizontal, and spaced apart from the front panel 102 of the set top box 100. In one embodiment, the source 210 is substantially smaller than the illumination target in height and/or width, i.e., at least one of the source's height and width is smaller than the corresponding dimension of the target 110. For example, at least one of the height and width (i.e., height, or width, or both height and width) of the source 210 can be less than about 1/10 of the corresponding dimension of the target 110. The compact light source provides a considerable space-saving advantage over the larger lighting elements typically used in backlighting systems.

As shown in FIG. 2, the source 210 can be positioned at a distance (L) away from the inside surface of the front panel 102. This distance is generally determined by geometry of the set top box 100 (or housing 104) and layout of the printed circuit board 212. In one embodiment, distance L is greater than the width (W) of the front or protruded portion 202 of the light pipe 200. In general, a larger distance L will allow a larger target width W to be illuminated (due to a larger expanded light beam), with possible improvement in illumination uniformity. However, for a given or fixed light source intensity, a larger distance will also reduce the light intensity at the output.

Furthermore, the light path between the input end of the light pipe 200 and the output end does not have to be a straight line. A nonlinear light path can be achieved, for example, by providing the light pipe with one or more curves, or one or more angular surfaces for reflecting the light in different directions, as appropriate. If a thinner piece of plastic light pipe is used, it can also be physically bent during assembly inside a cabinet or housing.

FIG. 3 is a side view of the set top box 100 having the front panel illumination system with the exterior portion 202 of the light pipe 200 protruding through the front surface or panel 102. In this view, the exterior portion 202 of the light pipe 200 has a quadrilateral shape, with the bottom side 202B and top side 202T not being parallel to each other. The bottom side 202B has a positive slope (i.e. directed upward as it extends away from the front panel 102 and forms an acute angle (α) with respect to the surface of the front panel 102. The dashed lines illustrate how light can propagate upward towards the target 110 by reflecting off the sloped bottom side 202B. The angle (α), along with other dimensions of this protruded portion 202 can be adjusted according to specific performance needs, e.g., to provide desired light direction, illumination intensity, target area coverage, and so on. Furthermore, instead of an acute angle configuration, it is possible to have a curved bottom side or surface 202B, which can direct light towards the target 110 in directions different from those achievable using the acute angle from a flat bottom side. Aside from a polished surface, a reflective coating can also be used at the bottom surface 202B to enhance reflectivity.

Light reflected off the bottom side 202B exits the top 202T surface of the exterior portion 202 for illuminating target 110 at the front panel 102. The amount or percentage of light transmitted through the top surface 202T depends on various factors such as light pipe design (e.g., material, geometry), light source (e.g., different properties of light such as wavelengths or intensities), and so on. Selection of different design combinations can be made according to the specific illumination requirements.

As previously mentioned, the light pipe 200 can be designed to allow some light to exit a front surface 202F (as shown by the dotted arrow), so that the front portion 202 becomes illuminated and more visible to a viewer or user. This can be used as an indicator light, for example, to inform the user of the power-on status of the set top box 100, or for other desired appearance or effects. If the light pipe 200 is made of a transparent or translucent material, then a certain amount of light will exit the front surface 202F. The amount of transmitted light can be adjusted, or completely blocked, by using one or more coatings or suitable materials that are reflective or opaque, at the front surface 202F. Many coatings suitable for this purpose are available commercially, and known to one skilled in the art.

By selecting different combinations of configurations, dimensions and/or properties relating to the reflective surface 202B, top surface 202T, and front surface 202F, different illumination or visual effects can be achieved. For example, a more intense light can be provided through the front surface 202F compared to the light exiting the top surface 202T. The stronger light through the front surface 202F is more suitable for use as an indicator light (e.g., power on indicator), while a less intense light through the top surface 202T can provide more subtle illumination across the logos or target area on the front panel.

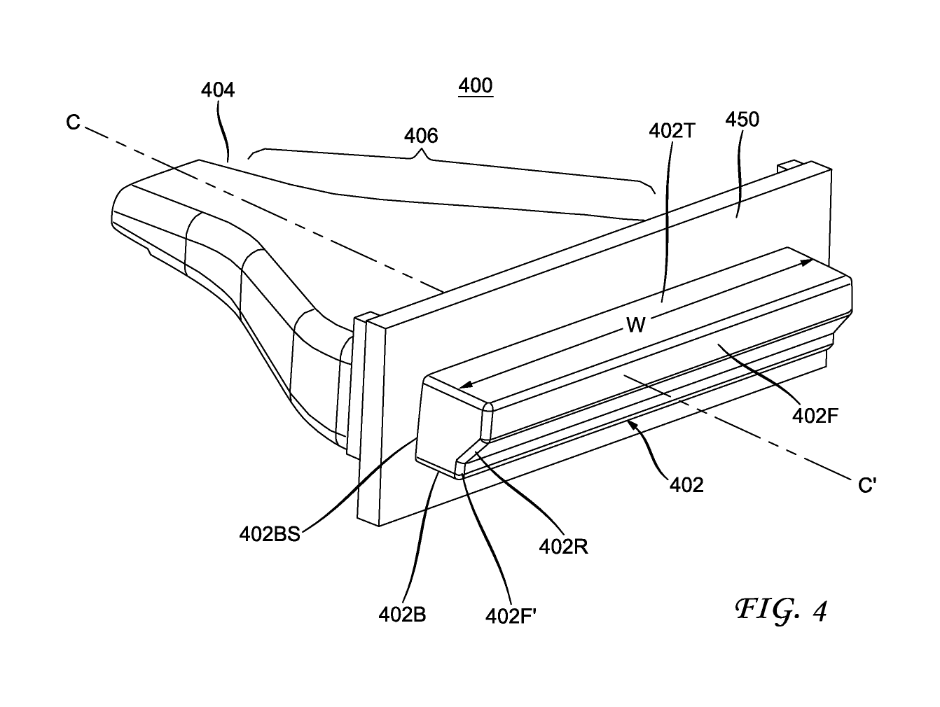

FIG. 4 shows a perspective view of another embodiment of a light pipe 400 suitable for panel illumination according to the present principles. The light pipe 400 has a middle portion 406 with a cross-sectional area that varies along the length or central optical axis CC′ of the light pipe 400. The middle portion 406 lies between a light input portion 404 (or simply, input portion), which couples light into the light pipe 400, and a light output portion 402 (or simply, output portion), which delivers or directs light to a target area requiring illumination.

The input portion 404 has a smaller transverse cross-sectional area (i.e., perpendicular to the longitudinal CC′ axis) than that of the output portion 402. As a light beam propagates through the middle portion 406, its cross-sectional area is expanded due to the increasing cross-sectional area of the middle portion 406. This middle portion 406 is also the expanding light channel portion, having substantially the same properties as discussed in connection with previous examples and FIGS. 2-3. The expanded light beam at the output portion 402 (e.g., having a width W) can provide illumination to a target area that is considerably larger than that of the light source or the light input portion 404 of the light pipe 400.

As shown in FIG. 4, the output portion 402 has a side profile (or cross-section view in a vertical plane passing through the longitudinal axis CC′ of the light pipe 400) in the form of a polygon. In this example, the output portion 402 has a side profile of a six-sided polygon, consisting of a back side 402BS, top side 402T, first front side 402F, reflective side 402R, second front side 402F′, and a bottom side 402B. The top and bottom sides 402T and 402B are substantially parallel to each other, and are configured to be perpendicular to the two front sides 402F and 402F′, both of which are also substantially parallel to each other.

In this configuration, light entering the back side 402BS from the middle portion 406 reflects off the reflective side or surface 402R towards the top side or surface 402T. At least a large fraction, if not all, of the reflected light exits the top surface 402T for illuminating a target area (not shown) located above the top portion 402. Similar to the examples in FIGS. 2-3, by directing the light at grazing incidence to the target area, a larger illuminated area can be achieved.

If no reflective coating is applied to the other sides or surfaces 402F, 402F′ and 402B, and light directed at these surfaces is not otherwise blocked, these surfaces will also allow light to pass through, and thus, appear illuminated to a viewer.

In one embodiment, the first front side or surface 402F is light reflecting, so that light will not be transmitted through this front surface 402F. In another example, at least one of the two front surfaces 402F and 402F′ (i.e., the first or second front surface, or both surfaces) is configured as partly reflective and partly transmissive, so that one or both surfaces will be illuminated.

Similar to the example in FIG. 3, the reflective surface 402R is provided at an angle such that incident light from the middle portion 406 of the light pipe 400 is reflected towards the top surface 402T, so that light exiting the top surface 402T can be directed to illuminate a target at grazing incidence. Such a configuration is well-suited for illuminating target areas on an exterior surface of an apparatus housing or enclosure, if the output portion 402 is mounted on the exterior of the apparatus housing.

In one implementation, the light pipe 400 is a single molded part made of one plastic material. Suitable materials such as a coating or mirrored surface can also be added to the reflective surface 402R if improved illumination is needed.

FIG. 4 also shows a vertical, and generally planar, flange 450, which can be used to attach or mount the light pipe 400 to a housing or panel of an apparatus. The exterior or output portion 402 is positioned on one side of the flange 450 and the expanding light channel portion 406 is on the other side of the flange 450. When attached to a panel of an apparatus housing, e.g., front panel of a set top box, the light input end 404 of the light pipe 400 will be aligned with a light source inside the apparatus housing, and the output portion 402 will be aligned with a target on an exterior surface of the apparatus housing, such that light coupled from the source is used for illuminating the target. In one embodiment, the light pipe 400 is attached to an apparatus housing so that the top and bottom surfaces 402T and 402B are substantially horizontal, and the front surfaces 402F and 402F′ are substantially vertical.

Although in the examples above, the light pipe is configured for light to exit a top surface for illuminating a target located above the output portion, it is understood that the light pipe can generally be positioned in different orientations so that the light from the output portion can be used to illuminate a corresponding target from any directions, including a target that may be located below, or to the right or left side of the light output surface.

Furthermore, aside from the examples discussed above, other variations or configurations can be used, including different combinations of dimensions or properties of the light pipe. Thus, the output portion of the light pipe can be a geometric figure with a number of sides or surfaces and angles that are different from those illustrated above, as long as there is a reflective surface configured for directing sufficient light to exit a surface for illuminating an exterior surface of a target (e.g., surface of any panel or housing, or logos on the panel, and so on). In general, most, if not all, surfaces on the light input and middle portions of the light pipe also play a role in light propagation along the pipe.

While the foregoing is directed to various embodiments of the present invention, other embodiments of the invention may be devised without departing from the basic scope thereof. For example, one or more features described in the examples above can be modified, omitted and/or used in different combinations. Thus, the appropriate scope of the invention is to be determined according to the claims that follow.

1. A light pipe for illuminating an exterior surface of an enclosure, comprising:
a first portion inside the enclosure for receiving light from a source; and
a second portion for directing the received light onto the exterior surface of the enclosure.

2. The light pipe of claim 1, wherein the second portion is located outside the enclosure.

3. The light pipe of claim 1, wherein the second portion includes a reflecting surface for directing the received light onto the exterior surface of the enclosure.

4. The light pipe of claim 1, wherein the second portion has a reflective surface for directing light through a transmissive surface onto the exterior surface of the enclosure.

5. The light pipe of claim 1, wherein the received light is directed at grazing incidence to the exterior surface of the enclosure.

6. The light pipe of claim 1, wherein the second portion has a front transmissive surface for passing at least a portion of the received light.

7. The light pipe of claim 1, wherein the first portion has an input end with a cross-sectional area smaller than a cross-sectional area of an output end of the second portion.

8. The light pipe of claim 1, comprising a material selected from the group consisting of plastic, glass, and metal.

9. A method of illuminating an exterior surface of an enclosure, comprising:
coupling light into a first portion of a light pipe inside the enclosure; and
directing light from the light pipe onto the exterior surface of the enclosure.

10. The method of claim 9, further comprising:
using a reflective surface of a second portion of the light pipe to direct light through a transmissive surface of the second portion onto the exterior surface of the enclosure.

11. The method of claim 9, further comprising:
directing light from the light pipe at grazing incidence onto the exterior surface of the enclosure.

12. The method of claim 9, further comprising:
providing a middle portion of the light pipe for increasing a cross-sectional area of light propagating from the first portion to the second portion of the light pipe.

13. The method of claim 9, further comprising:
illuminating a target on the exterior surface of the enclosure by directing the light from the second portion of the light pipe.

14. A system for illuminating an exterior surface of an enclosure, comprising:
a light source inside the enclosure;
a light pipe having a first portion inside the enclosure for receiving light from the light source; and a second portion for directing the received light onto the exterior surface of the enclosure.

15. The system of claim 14, wherein the second portion is located outside the enclosure.

16. The system of claim 14, wherein the second portion includes a reflecting surface for directing the received light onto the exterior surface of the enclosure.

17. The system of claim 14, wherein the second portion has a reflective surface for directing light through a transmissive surface onto the exterior surface of the enclosure.

18. The system of claim 14, wherein the reflective surface is configured for directing the received light at grazing incidence onto the exterior surface of the enclosure.

19. The system of claim 14, wherein the second portion has a front transmissive surface for passing at least a portion of the received light.

20. The system of claim 14, wherein the first portion has an input end with a cross-sectional area smaller than a cross-sectional area of an output end of the second portion.

21. The system of claim 14, wherein the light source is selected from at least one light emitting diode and at least one laser diode.
